(19) United States
(12) Patent Application Publication
(10) Pub. No.: US 2025/0333300 A1
(43) Pub. Date: Oct. 30, 2025

(54) Hydrocarbon Pyrolysis in a Forced Circulation Reactor System

(71) Applicant: EXXONMOBIL TECHNOLOGY AND ENGINEERING COMPANY, Spring, TX (US)

(72) Inventors: Joseph S. Famolaro, Spring, TX (US); Steven Pyl, Houston, TX (US); Sarah E. Feicht, Branchburg, NJ (US); Laurien A. Vandewalle, Houston, TX (US); Keith C. Gallow, Kingwood, TX (US)

(21) Appl. No.: 19/192,520

(22) Filed: Apr. 29, 2025

Related U.S. Application Data
(60) Provisional application No. 63/640,364, filed on Apr. 30, 2024.
(60) Provisional application No. 63/640,356, filed on Apr. 30, 2024.
(60) Provisional application No. 63/640,411, filed on Apr. 30, 2024.

(51) Int. Cl. C01B 3/30

(52) U.S. Cl. CPC C01B 3/30; C01B 2203/0277; C01B 2203/0833; C01B 2203/085; C01B 2203/0866; C01B 2203/1241; C01B 2203/1247

(57) ABSTRACT

Systems and methods are provided for forming particles containing pyrolysis coke during a forced-circulation hydrocarbon pyrolysis process. The gaseous hydrocarbon pyrolysis configuration described herein provides reduced coke fouling of the pyrolysis system. This is achieved using a forced circulation reactor design to move circulating coke through the reactor system. The gaseous hydrocarbon pyrolysis configuration is proposed to prevent the undesirable operational affects that occur in reaction zones that do not contain solid particles by maintaining an amount of solid particles above a threshold solids density in areas of the system with pyrolysis conditions. The threshold solids density is a density at which carbon formed during the pyrolysis reaction will have increased selectivity for depositing on circulating solid (coke) particles, while reducing or minimizing coke deposition on system surfaces.

### CROSS-REFERENCE TO RELATED APPLICATIONS AND PRIORITY CLAIM

This Non-Provisional Patent application claims priority to U.S. Provisional Patent Application No. 63/640,364, filed Apr. 30, 2024, and titled “Hydrocarbon Pyrolysis And Pyrolysis Coke Particle Production”, U.S. Provisional Patent Application No. 63/640,356, filed Apr. 30, 2024, and titled “Proppant Particulates Formed By Methane Pyrolysis And Methods Related Thereto”, and U.S. Provisional Patent Application No. 63/640,411, filed Apr. 30, 2024, and titled “Pyrolysis Coke”, the entire contents of which is incorporated herein by reference.

### FIELD OF THE INVENTION

Systems and methods are provided for performing methane pyrolysis while forming pyrolysis carbon particles.

### BACKGROUND OF THE INVENTION

Pyrolysis of hydrocarbons is a technology that provides a potential pathway for producing large volumes of H₂ while reducing or minimizing the amount of carbon oxides that are generated. Instead of forming substantial amounts of carbon oxides, pyrolysis allows for formation of solid carbon products.

While H₂ generated by pyrolysis has a variety of uses, there is continuing interest in developing uses for the solid carbon generated during hydrocarbon pyrolysis. One option is to use the solid carbon for formation of carbon nanotubes. This is described, for example, in U.S. Pat. No. 11,629,056.

Another option is to form carbon particles. For example, a variety of prior methods have focused on pyrolysis methods that form carbon black. Carbon black typically corresponds to particles on the order of 1.0 μm or smaller. Carbon black can be used in a variety of applications related to use as a pigment, colorant, or conductive additive, as well as uses as filler material in rubber-based products (such as tires) or plastic products.

As an alternative to carbon black, larger particles and/or bulk carbon can be formed. Conventionally, larger particles of pyrolysis carbon have been used primarily for fuel value. It would be desirable to develop additional economic uses for the pyrolysis coke formed during hydrocarbon pyrolysis.

U.S. Pat. No. 4,796,701 describes formation of particles corresponding to an outer layer of pyrolysis coke deposited on an inner core. The pyrolysis coke is deposited on the particles using a controlled fluidized bed process that is operated in batch mode. In this batch mode, the initial bed of “core” particles for forming the bed is of a uniform size, and then fluidized bed pyrolysis is performed until a target thickness of pyrolysis coke is deposited on the particles. Thus, the resulting particles are of roughly a uniform size. The particles are described as being roughly spherical. Depending on the conditions selected, the outer layer of pyrolysis coke is described as having a uniform thickness ranging from 5 μm to 200 μm. It is noted that a “thickness” of 5 μm for the deposited carbon layer would correspond to an increase in diameter for a particle of 10 μm, while a thickness of 200 μm would correspond to an increase in diameter of 400 μm for a particle. The examples describe use of an inner core having a size of 30 mesh to 50 mesh, which corresponds to a minimum size for the inner core of roughly 300 μm. U.S. Pat. No. 4,632,876 is described as another example of suitable ceramic particles for the inner core. U.S. Pat. No. 4,632,876 describes formation of ceramic particles having a particle size at the end of particle formation of 180 μm or more.

U.S. Patent Application Publication 2002/0037247 describes deposition of pyrolytic carbon on “whiskers” or “fibers” of inorganic material that have a diameter of less than 1 micron and a surface area of 10 m²/g or more.

U.S. Patent Application Publication 2021/0331918 describes pyrolysis of hydrocarbons (such as methane) using stacked fluidized beds to improve conversion during pyrolysis. International Publication WO/2022/081170 describe pyrolysis of hydrocarbons (such as methane) using stacked fluidized beds in combination with using electric heating to provide at least a portion of the heat for the pyrolysis reaction.

U.S. Patent Application Publication 2023/0271899 describes using a mixed bed of electrically conductive particles and catalytic particles as part of a fluidized bed pyrolysis process to assist with heating of the fluidized bed via direct resistance heating of the particles in the fluidized bed by passing a current through at least a portion of the particles. The particles in the fluidized bed are described as being electrically conductive particles and catalytic particles. The fluidized bed contains at least 10 wt % of the electrically conductive particles with a resistivity of 500 Ohm-cm or less at 800° C. At least a portion of the electrically conductive particles are selected from silicon carbide, one or more metallic alloys, non-metallic resistors, metallic carbides, transition metal nitrides, metallic phosphides, graphite, carbon black, superionic conductors, phosphate electrolytes, mixed oxides doped with lower-valent cations. In addition the fluidized bed contains catalytic particles, comprised of metallic compounds.

### SUMMARY OF THE INVENTION

In various embodiments, a process for performing hydrocarbon pyrolysis is provided. The process includes pyrolyzing a hydrocarbon-containing flow in the presence of solid particles under pyrolysis conditions in a reactor to form an H₂-containing effluent and coke deposited on at least a portion of the solid particles, the hydrocarbon-containing flow and the solid particles forming a gas-solids mixture within the reactor under forced circulation conditions. Optionally, substantially all of the gas-solids mixture has a solids density of 0.1 lbs/ft³ (˜1.6 kg/m³) or more while exposed to pyrolysis conditions within the reactor. Optionally, the gas-solids mixture has a gas velocity of 0.1 ft/s (˜0.03 m/s) or more while exposed to pyrolysis conditions within the reactor. At least a portion of the gas-solids mixture exposed to the pyrolysis conditions within the reactor can have a gas velocity of 20 ft/s (˜6.1 m/s) or more, the pyrolysis conditions including a temperature of 700° C. to 1600° C. The process further includes passing the H₂-containing effluent and a transfer portion of the solid particles in the gas-solids mixture upwards through the reactor into a separation vessel to produce an H₂-containing product and a solids product containing solid particles having deposited coke. Additionally, the process includes passing at least a portion of the solids product into the reactor.

Optionally, the gas-solids mixture can have a fluidized bed portion having a gas velocity of 0.1 ft/s (˜0.03 m/s) or more and a dilute phase having a solids density of 0.1 lbs/ft³ (˜1.6 kg/m³) or more and a gas velocity of 20 ft/s (˜6.1 m/s) or more. Optionally a lift velocity in the fluidized bed portion maintains a solids density of 25% to 100% of minimum fluidization density. Alternatively, the gas/solids mixture can be a suspension of solid particles having a gas velocity of 20 ft/s (˜6.1 m/s) or more.

### BRIEF DESCRIPTION OF THE DRAWINGS

FIG. 1 shows an example of a reaction system for performing hydrocarbon pyrolysis.

FIG. 2 shows another example of a reaction system for performing hydrocarbon pyrolysis.

### DETAILED DESCRIPTION OF THE EMBODIMENTS

All numerical values within the detailed description and the claims herein are modified by “about” or “approximately” the indicated value, and take into account experimental error and variations that would be expected by a person having ordinary skill in the art.

### Overview

In various aspects, systems and methods are provided for forming particles containing pyrolysis coke during a forced-circulation hydrocarbon pyrolysis process. The gaseous hydrocarbon pyrolysis configuration described herein provides reduced coke fouling of the pyrolysis system. This is achieved using a forced circulation reactor design to move circulating coke through the reactor system. The gaseous hydrocarbon pyrolysis configuration is proposed to prevent the undesirable operational affects that occur in reaction zones that do not contain solid particles by maintaining an amount of solid particles (such as coke particles) above a threshold solids density in areas of the system with pyrolysis conditions (e.g., the reactor). The threshold solids density is a density at which carbon formed during the pyrolysis reaction will have increased selectivity for depositing on circulating solid (coke) particles, while reducing or minimizing coke deposition on system surfaces. The reactor effluent is fed to a solids separation device, such as a cyclone, to create a gas stream (e.g., hydrogen) with minimal remaining solid carbon particles, and a separated carbon stream.

The gas effluent from the solid separation device is potentially rapidly cooled to terminate pyrolysis reactions, which minimizes coking of effluent equipment and/or formation of extremely fine free coke. Cooling of the gas effluent substantially limits pyrolysis conditions to the reactor. The flow path for the carbon stream exiting the solid separation device is dependent on the nature of the heating system for providing the heat for the pyrolysis reaction.

In some aspects, the carbon stream exiting the solid separation device is fed to a heating system to add sufficient heat to support the heating requirements of the reactor system. The heated carbon stream from the heating system is then routed back to the reactor system, thereby, forming a solid carbon circulation loop. In other aspects, the heating system for heating the pyrolysis particles can be integrated with the reactor, so that the solid circulation loop corresponds to passing the carbon particles from the reactor to the solids separation device and the returning the particles to the reactor. At some point in the circulation loop a carbon stream is withdrawn to maintain an approximately constant inventory of solid carbon particles in the reactor and heating system. During operation, seed carbon may be added to replace a portion of withdrawn carbon to maintain a particle size distribution within a desired range. Generally, the coke removed may have particles across a size spectrum. It may be desirable to return coke particles on the small end of the spectrum back to the reactor as seed coke, while comparatively larger coke particles are included in the coke output from the system. In aspects, the inventory may be measured by an amount of carbon particles.

Methane pyrolysis can be used to exemplify a hydrocarbon pyrolysis reaction. Equation (1) shows a basic stoichiometric formula, not including intermediate reactions and side products.

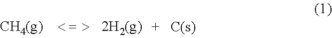

As shown in Equation (1), methane pyrolysis results in formation of hydrogen gas and some type of solid form of carbon. The nature of the solid carbon formed can depend on the reaction environment.

One of the difficulties with using hydrocarbon pyrolysis for production of hydrogen is that even for the most favorable hydrocarbon (i.e., methane), the carbon atoms in the hydrocarbon correspond to at least 75% of the weight in the hydrocarbon. Thus, by weight, the vast majority of the product formed during hydrocarbon pyrolysis corresponds to the carbon product(s).

It has been determined that when performing hydrocarbon pyrolysis, one of the difficulties is that the resulting solid carbon formed during pyrolysis will tend to deposit on surfaces based on proximity of the surface to the pyrolysis reaction and the amount of available surface area. This causes difficulties for commercial scale production of hydrogen, as at least a portion of the solid carbon product will be formed on surfaces of the reaction vessel used for performing the hydrocarbon pyrolysis. Such carbon deposited on interior surfaces of the reaction vessel typically leads to problematic equipment fouling or plugging, limiting process capacity and/or stability; and also corresponds to a waste product and/or a product with low commercial value. Solid carbon formed from reaction chemistry in locations where no solid carbon particles or vessel surfaces are present can lead to formation of “free coke”, which can be characteristically fine (small in size), difficult to capture, problematic for downstream equipment, and low value given the particle size is outside of the desired range. Therefore, it would be beneficial to provide pyrolysis methods and corresponding systems that assure the presence of sufficient carbon particles while pyrolysis reactions are occurring.

In various aspects, pyrolysis can be performed in a fluidized bed environment, such as in a forced circulation reactor. Without being bound by any particular theory, by using one or more fluidized beds as the pyrolysis environment, the proximity of the particles in the fluidized bed can allow for the carbon to preferentially be deposited on the particles in the fluidized bed, thus reducing or minimizing the amount of carbon deposited at other locations, such as interior surfaces of the reactor(s) containing the fluidized bed(s). This is in contrast to, for example, pyrolysis methods that involve substantial nucleation of new carbon particles. Nucleation of a new particle is typically a longer time scale process than deposition on an existing surface. Thus, processes involving substantial particle nucleation can tend to have larger losses of carbon to deposition of carbon on interior surfaces of a reaction vessel.

Nucleation may be minimized and/or avoided by maintaining the coke density (or other solids density) above a certain threshold within the pyrolysis environment. The pyrolysis environment is the environment where conditions exist to enable pyrolysis. A forced circulation fluidized bed pyrolysis system has been found to minimize coke formation on the reactor walls and/or other system components (such as transfer lines and cyclones) by maintaining a threshold coke density throughout the reactor. In contrast, more traditional fluidized bed pyrolysis systems, including a lower fluidized bed with an upper very dilute zone, may fail to maintain a coke density above the threshold in one or more portions of the reactor, such as the upper portion of the reactor. Coke is more likely to be deposited on the reactor walls when coke density is below this minimum threshold.

In aspects, the minimum threshold coke density has been discovered to be greater than 0.01 lbs/ft³ gas, such as 0.02 lbs/ft³ or greater, such as 0.1 lbs/ft³ or greater, such as 1 lbs/ft³ or greater, such as up to 2 lbs/ft³.

### Definitions

As used herein, the term “particle density” refers to the density of the individual particulates themselves, which may be expressed in grams per cubic centimeter (g/cm³). Unless otherwise specified, particle density is measured using He pycnometry according to ASTM D2638-21. It is noted that particle density, which can also be referred to as “skeletal density”, differs from “real density” due to the fact that inaccessible porous domains may remain within the particulates that would result in deviations from the intended definition of “real density: as defined in ASTM D2638-21.

As used herein, the term “bulk density” refers to the density of a collection, group, or other plurality of particles, which may be expressed in g/cm³. Unless otherwise specified, bulk density is measured according to ASTM D4292-23.

As used herein, D10, D50, and D90 describe particle sizes. As used herein, the term “D10” refers to a diameter at which 10% of the sample (on a volume basis unless otherwise specified) is comprised of particles having a diameter less than said diameter value. As used herein, the term “D50” refers to a diameter at which 50% of the sample (on a volume basis unless otherwise specified) is comprised of particles having a diameter less than said diameter value. As used herein, the term “D90” refers to a diameter at which 90% of the sample (on a volume basis unless otherwise specified) is comprised of particles having a diameter less than said diameter value. Generally, particle size can be determined by light scattering techniques (which uses a model in the data reduction to approximate the object as a sphere, and therefore provides a diameter) or analysis of optical digital micrographs (which uses a circular-equivalent cross-section, and therefore provides a diameter). Unless otherwise specified, light scattering techniques (and/or methods which provide a diameter equivalent to light scattering techniques) are used for analyzing particle size and for determining diameter. Unless otherwise specified, the particle sizes are determined according to ASTM D4464-15 (2020). It is noted that ASTM D4464-15 (2020) pertains to “catalyst, catalyst carrier, and catalytic raw material particles”; carbon particles are common catalyst carriers and therefore understood by those skilled in the art to fall within the scope of ASTM D4464-15 (2020).

Unless otherwise specified, in this discussion, the ash content of particles is determined according to ASTM D4422-19. The moisture content of particles is determined according to ASTM D3173/D3173M-17a. The volatile matter content of particles is determined according to ASTM D6374-22. The results for ash content, moisture content, and volatile matter content can be used to calculate the fixed carbon content of particles.

Unless otherwise specified, in this discussion, the sulfur content of particles is determined according to ASTM D1552-23.

Unless otherwise specified, in this discussion, the carbon, hydrogen, and nitrogen content of particles are determined according to ASTM D5373-21. After characterization of carbon, hydrogen, nitrogen, and sulfur, oxygen content can be calculated as the balance of the composition.

Metals content, such as the content of iron, nickel, and vanadium, is determined according to ASTM D5600-22.

Unless otherwise specified, in this discussion, X-Ray Diffraction (XRD) is used to determine the layer spacing (d₀₀₂) within particles. XRD in combination with Scherrer analysis is used to determine crystallite size (Lc and La calculated from the widths of the d₀₀₂ and d₁₁₀ peaks, respectively).

In this discussion, BET surface area is specific surface area measured by N₂ adsorption and Brunauer-Emmett-Teller analysis. BET surface area is determined according to ASTM D6556-21. It is noted that this test is traditionally for carbon black, but it is also applicable for the types of particles described herein.

In this discussion, calorific value is determined according to ASTM D5865/D5865M-19.

### Forced Circulation Fluidized Bed Pyrolysis

Operating a reaction system under forced circulation conditions provides a combination of solids (coke) density, mass velocity, and gas velocity within a pyrolysis reactor that is not achieved by other types of conventional strategies for performing pyrolysis. Conventionally, forced circulation reactors have not been used for hydrocarbon pyrolysis. This is due to a variety of factors. First, most conventional pyrolysis systems have been focused on recovery of hydrogen, with the carbon generated during pyrolysis viewed as a side product. Thus, the focus of many conventional pyrolysis systems was on facilitating separation of solids from the hydrogen-containing gas phase, in order to improve overall hydrogen recovery. In conventional fluidized bed systems, the dilute region above the fluidized bed is typically at a solids concentration below 0.01 g/ft³ of gas, making it relatively easy to separate the remaining solids from the gas phase.

Conventionally, bubbling bed/fluidized bed systems for pyrolysis provide a variety of advantages for performing hydrocarbon pyrolysis and then separating the hydrogen-containing product gas flow from the solids in the reactor. First, because the particle bed in a fluidized bed reactor is fluidized, but the particles do not need to be lifted to the top of the reactor, relatively low gas velocities can be used. This allows for higher gas residence times within the pyrolysis reactor. Additionally, the majority of the separation of the hydrogen-containing gas product from the solids is performed when the gas exits from the fluidized bed into the dilute region above the bed. In a conventional configuration, this dilute region has a solids (coke) density of less than 0.01 g/ft³, and therefore the solids density is well below 0.1 g/ft³. This means that only a modest amount of additional separation of solids has to be performed to separate substantially all of the solids from the hydrogen-containing product gas flow.

Generally, performing pyrolysis in a riser reactor has not been a preferred configuration. This is due to the higher gas velocities in riser reactors, which reduces gas residence time within the pyrolysis zone, making it more difficult to drive the pyrolysis reaction closer to completion. Additionally, to the degree that a riser reactor would have been considered in a conventional context, the configuration would have focused on dilute operation, with a solids density of less than 0.01 g/ft³. Similar to a fluidized bed situation, this would facilitate separation of solids from the hydrogen-containing product gas flow.

An alternative conventional configuration for pyrolysis is to use a moving bed, with a counter-current gas flow. In this type of configuration, there is effectively no lift of the particles at all by the gas flow, as the flow of the moving bed is typically drive by gravity. Thus, once again, the hydrogen-containing product generated from a moving bed configuration has little or no entrained solids. Additionally, because little or no fluidization of particles is required to operate in a moving bed configuration, longer gas residence times can be used to assist with controlling the pyrolysis reaction. It is additionally noted that for a moving bed, the particles in the bed are typically not well-mixed, so that substantial temperature gradients and/or poor distribution of gases can occur in a moving bed environment.

Relative to conventional configurations for hydrocarbon pyrolysis, a forced circulation reactor operates with a co-current gas flow while maintaining substantially higher coke density throughout the portions of the forced circulation reaction system where hydrocarbons (such as methane) are in contact with coke particles at pyrolysis temperatures. For example, in a conventional bubbling bed/fluidized bed pyrolysis reaction system, the fluidized bed itself may have a relatively high coke density. However, in a conventional fluidized bed reactor, there is a volume above the fluidized bed in the reactor that has a substantially lower density of coke particles. In this volume above the fluidized bed, the density of particles will be below 0.01 g/ft³ of gas. Thus, a conventional fluidized bed configuration will have a substantially increased tendency to deposit coke on interior surfaces of the reaction system within this volume above the fluidized bed. In addition to reducing the amount of pyrolysis carbon that can be recovered as a product, this also can result in increased reactor downtime, due to the need for more frequent maintenance as pyrolysis carbon accumulates within a reactor.

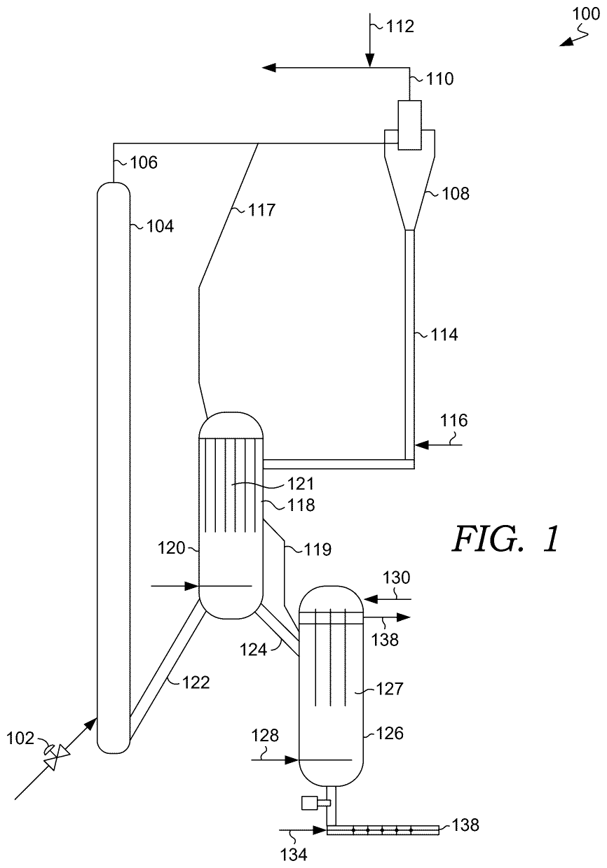

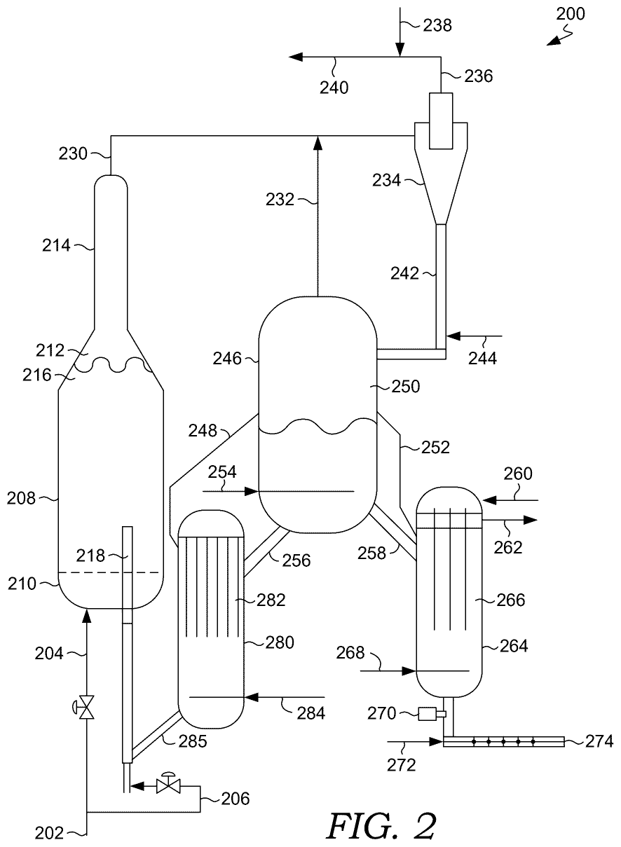

A variety of options are available for performing pyrolysis under forced circulation conditions. Some examples are provided in FIG. 1 and FIG. 2. In these two examples, pyrolysis is performed in one or more pyrolysis vessels, but in a forced circulation configuration where a solids density of 0.01 g/ft³ or higher (or 0.1 g/ft³ or higher, or 0.2 g/ft³ or higher) is maintained throughout the reactor vessel until separation of the solids from the gas. In the configurations shown in FIG. 1 and FIG. 2, one or more additional vessels are used to add heat to the particles in the reaction system, and a third vessel is used for cooling the coke particles prior to removal from the system. All three vessels may keep a substantial portion of the coke particles in a fluidized state. The fluidization of the particles facilitates movement between the vessels to allow the heat added in the one or more additional vessels to be balanced against the heat consumed by the endothermic pyrolysis reaction. In other types of configurations, heating of the particles is performed in the same vessel as where the pyrolysis reaction occurs. More generally, any convenient fluidized bed/other fluidized pyrolysis configuration can be used, so long as the configuration allows for circulation of coke particles throughout the system in order to maintain a minimum solids (coke) density in areas under pyrolysis conditions, and provides at least some control over the pyrolysis conditions and the average residence time for particles under pyrolysis conditions.

The solid particles used for forming the fluidized bed and/or suspension of solid particles in a gas flow can be of various types, depending on the embodiment. Generally, the solid particles within the reaction system can correspond to particles having a core of some type of “seed particle” material with pyrolysis carbon deposited on the core. In some embodiments, the solid particles can be substantially composed of pyrolysis carbon. For example, seed particles of pyrolysis carbon can be introduced into the reaction system. As the particles pass through the pyrolysis reactor, additional pyrolysis carbon is deposited on the particles, so that the entire particle corresponds to pyrolysis carbon. In other embodiments, the seed particles can be different from pyrolysis carbon. This can include seed particles that are substantially composed of carbon, but are formed in a manner so that the seeds do not correspond to pyrolysis carbon. Examples of such seed materials (seed particles) include, but are not limited to, fluidized coke particles, activated carbon particles, amorphous carbon particles, and/or any other convenient type of solid carbon particles. In other embodiments, the seed particles can be at least partially composed of materials other than carbon. Examples of other types of seed particles include, but are not limited to, sand (or other types of silica), ceramic particles, and silicon carbide particles.

Still another option can be to include a portion of catalyst particles within the solid particles. The catalyst particles can facilitate the pyrolysis reaction, so that temperatures as low as 700° C. can be used for pyrolysis. In the absence of catalyst particles, temperatures of 800° C. or higher are typically required. The catalyst particles can correspond to any convenient percentage of the solid particles within the reactor. In some aspects, catalyst particles and/or particles having a catalyst particle core with some amount of deposited pyrolysis carbon can correspond to 15 wt % or less of the particles in the pyrolysis reactor, or 10 wt % or less, or 5.0 wt % or less, such as down to 0.1 wt % or possibly still less. Of course, catalyst particles are optional, so in various embodiments, no catalyst particles will be present within the solid particles in the reactor.

Generally, the temperature in the pyrolysis reaction zone of the reaction system, in the heating portion of the reaction system, or in both the pyrolysis reaction zone and the heating portion can be from 700° C. to 1600° C., or 700° C. to 1400° C., or 700° C. to 1300° C., or 800° C. to 1600° C., or 800° C. to 1400° C., or 800° C. to 1300° C., or 1000° C. to 1600° C., or 1000° C. to 1400° C., or 1000° C. to 1300° C., or 1200° C. to 1600° C., or 1200° C. to 1300° C. The pressure in the pyrolysis reaction zone and/or heating portion of the reaction system can be 1.0-30 bar (˜100 kPa-a to ˜3000 kPa-a), or 1.0 bar-20 bar (˜100 kPa-a to 2000 kPa-a), or 1.0-10 bar (˜100 kPa-a to ˜1000 kPa-a), or 1.0-5.0 bar (100 kPa-a to 500 kPa-a), or 2.0-30 bar (200 kPa-a to 3000 kPa-a), or 2.0-20 bar (200 kPa-a to 2000 kPa-a), or 2.0-10 bar (200 kPa-a to 1000 kPa-a), or 2.0-5.0 bar (200 kPa-a to 500 kPa-a), or 5.0-30 bar (500 kPa-a to 3000 kPa-a), or 5.0-20 bar (500 kPa-a to 2000 kPa-a), or 10-30 bar (1000 kPa-a to 3000 kPa-a). The gas velocity in the heating portion of the reaction system can vary depending on the type of heating and the type of reaction system. When electric heating is used, the gas velocity can be 0.1 ft/s-10 ft/s (˜0.03 m/s to ˜3.3 m/s), or 0.5 ft/s to 3.0 ft/s (˜0.2 m/s to ˜0.9 m/s). For combustion heating in a separate vessel, the gas velocity can be 20 ft/s to 100 ft/s (˜6.5 m/s to 33 m/s), or 50 ft/s to 80 ft/s (˜17 m/s to ˜26 m/s).

It is noted that in this discussion, electric heating of particles (such as heating of a fluidized bed of particles) using radiative resistance heating is distinct from electric heating using direct resistance heating. In this discussion, radiative resistance heating of a particles corresponds to using an electric heater that transfers heat to particles, either via direct heat transfer to the particles, or indirectly by heating a reactor surface (such as a wall), which then transfers heat to the particles. It is noted that indirect heating of the particles by heating of reactor surfaces can correspond to resistive heating of the reactor surfaces and/or inductive heating of the reactor surfaces. The various heating methods above are in contrast to direct resistive heating of particles, which corresponds to including particles inside the reaction system that have sufficient electrical conductivity that the particles can be heated by passing an electric current through the particles.

In addition to direct resistive heating of particles, various other options are available for using particles as the mechanism for adding heat to the reaction system. One type of particle heating is direct contact fired heating where heat is provided by combustion of a fuel in the presence of particles and/or in close proximity to the particles. Another type of particle heating is indirect contact heating, where circulating solids are heat exchanged with a heating medium.

FIG. 1 and FIG. 2 show two types of reactor configurations for a pyrolysis reaction system operated under forced circulation conditions. FIG. 2 shows an example of a turbulent bed reactor with a top riser. This type of reactor can have a denser bottom region and a dilute top region. In this type of configuration, the gas velocity in the dense portion of the fluidized bed can be roughly 1.0 ft/s to 15.0 ft/s (˜0.3 m/s to ˜5.0 m/s). In the top riser section, the gas velocity can increase to roughly 20 ft/s to 100 ft/s (˜6.5 m/s to 33 m/s). This gas velocity increase is achieved while still maintaining a coke density of 0.1 g/ft³ or higher in the top riser portion. FIG. 1 shows an example of a riser reactor configuration that is operated under forced circulation conditions. In this type of configuration, the gas velocity can be roughly 20 ft/s to 100 ft/s (˜6.5 m/s to 33 m/s) in the reactor.

Turning now to FIG. 1, an example of a riser reactor system 100 is shown for performing pyrolysis of a hydrocarbon stream in a forced recirculation system. At a high level, the system 100 includes a riser reactor 104, a cyclone 108, a heater 118, a withdrawal cooler 126, and a coke withdrawal outlet 138. A reactor product line 106 connects the outlet of the riser reactor 104 to an inlet of the cyclone 108. A cyclone gas outlet line 110 is connected to a quenching system 112.

A cyclone dipleg114 connects an outlet of the cyclone 108 to a coke inlet in the heater 118. The heater includes an electrical heating element 121 that can be used to heat coke particles to a desired pyrolysis temperature. A coke return standpipe 122 connects a coke outlet nozzle from the heater 118 to a coke inlet nozzle in the reactor 104. A gas outlet line 117 connects the heater 118 to the reactor product line 106. A preheated feed inlet line 102 connects to a lower end of the riser reactor 104.

The coke withdrawal line 124 connects a coke outlet in the heater 118 to a coke inlet in the withdrawal cooler 126. The withdrawal cooler includes a heat exchanger 127 in fluid communication with a cooling fluid inlet 130 and in fluid communication with a cooling fluid outlet 132. A coke outlet in the lower end of the withdrawal cooler 126 is connected to a coke withdrawal outlet 138. A gas return line 119 connects the withdrawal cooler 126 to the heater 118.

As shown in FIG. 1, the system 100 includes multiple lines providing fluidizing gas. The cyclone dipleg 114 includes an inlet connected to a fluidizing gas line 116. The heater 118 includes an inlet connected to a heater fluidizing gas line 120. The cooler includes an inlet connected to a cooler fluidizing gas line 128. The withdrawal outlet 138 includes an inlet connected to withdrawal transport gas line 134. Providing fluidizing gas at various locations in the system 100 can facilitate movement of particles within the system, and also can assist with equilibrating temperatures in the heating and/or cooling portions of the system.

After a startup process, the riser reaction system 100 may reach steady state operating conditions that facilitate pyrolysis within the riser reactor 104 that involves circulation of a fluidized coke stream through the riser reactor 104, cyclone 108, and heater 118. Coke produced in the system 100 may be removed from the system in order to maintain control of vessel inventory/levels.

During operation, input feed 102, such as a methane or natural gas, can enter the riser reactor 104 from the bottom. The input feed 102 can serve as a fluidizing gas/lift medium for the solids in the riser reactor 104 as the gas flow moves up through the riser reactor 104. In various embodiments, sufficient fluidizing gas/lift medium and input feed 102 may be provided to cause a 20 ft/s to 100 ft/s (˜6.5 m/s to 33 m/s) gas velocity up the riser reactor 104. A fluidized riser reactor 104 contains solid coke particles in suspension with the upward flowing gas flow. The gas velocity is sufficiently high to lift the solids to the top of the riser reactor 104, where the gas/solids mixture flows into the cyclone 108. The riser height depends on process requirements and design considerations. The factors to consider are gas residence time to exchange heat with circulating solids and sufficiently complete pyrolysis reactions, and sufficient height for layout of equipment downstream of the riser reactor. In aspects, a riser reactor height of 50-250 feet (15 m-76 m) may be sufficient when the particle density is from 0.1 to 10 lb/ft³ (˜1.6 to ˜160 kg/m³) and the gas velocity is from 20 ft/s to 100 ft/s (˜6.5 m/s to 33 m/s).

The solids density in the riser reactor 104 is affected by several factors, but primarily by the solids circulation rate into the riser reactor from the inlet standpipe 122. There are multiple methods of controlling the solids circulation rate, including use of a mechanical valve, such as a slide valve or plug valve, appropriately designed for the system operating conditions. Alternatively, an appropriately designed non-mechanical valve can be utilized for circulation control, such as a controlling L-valve, which manipulates an aeration rate in moving packed bed flow. The target solids circulation rate considers several factors, including the target riser reactor solids density to avoid equipment fouling and “free coke” formation; as well as the circulation rate required to deliver the required heat to the reactor vapors to control riser reactor temperature.

As the input feed 102 moves through the riser reactor 104, the input feed 102 is heated by the fluidized coke particles. This results in pyrolysis of at least a portion of the input feed 102 to H₂, so that hydrogen-containing product gas flow is formed. The pyrolysis also produces solid carbon that is deposited primarily on recirculating coke particles. The hydrogen-containing product gas flow and a portion of coke particles enters the reactor product line 106 and are transported to an inlet of the cyclone 108.

The cyclone 108 separates solids from gases. The separated solids include coke particles that pass through the cyclone dipleg 114 and into the heater 118. Fluidizing gas be provided through the fluidized gas port 116 to assist in transportation of the coke particles into the heater 118. The separated gas includes the hydrogen-containing product gas which may be quenched and then transported to a hydrogen handling system for further processing and/or use.

The cyclone 108 may be a high-temperature cyclone that includes a cylindrical or conical vessel with an inlet for the gas stream and an outlet for clean gas. The gas enters tangentially, creating a swirling motion inside the cyclone. As the gas swirls, centrifugal forces push the particulate matter outward toward the cyclone walls. The heavier particles move toward the outer wall due to their inertia. Clean gas, with reduced particle content, continues upward toward the outlet. The collected particles (e.g., coke particles) accumulate at the bottom of the cyclone (the collection zone) and exit into the cyclone dipleg 114.

The heater 118 may be an electrically heated fluidized bed (EHFB), which is a system used to heat fluidized beds using electricity. EHFBs replace fossil fuel combustion with direct electric heating. They offer a low-carbon option for various industrial applications. EHFBs can use different heating methods. In various aspects, resistive heating may be used. FIG. 1 shows heating elements 121 that are used during resistive heating. However, other possible heating methods include a direct contact fired heating system whereby hot combustion gases contact and exchange heat with the circulating solids; indirect contact fired heating system, whereby hot combustion gases exchange heat to circulating coke through a heat exchange device; microwave, induction, and electromagnetic irradiation. The particles are heated above the pyrolysis temperatures. Fluidizing gas line 120 adds sufficient gas to facilitate transportation of the particles and to maintain a fluidized particle state within the heater 118. A first portion of the heated particles may be transferred through the lower coke standpipe 122 to the riser reactor 104.

Turning now to FIG. 2, an example of a forced circulation reactor system 200 for performing fluidized bed pyrolysis of a hydrocarbon stream, is shown according to aspects of the technology described herein. At a high level, the system 200 includes a reactor 208, a cyclone 234, a surge vessel 246, a heater 280, a withdrawal cooler 264, and a coke withdrawal outlet 274. A reactor product line 230 connects the outlet of the reactor 208 to an inlet of the cyclone 234. A cyclone gas outlet line 236 is connected to a quenching system 238.

A cyclone dipleg 242 connects an outlet of the cyclone 234 to an upper inlet in the surge vessel 246. A surge drum outlet standpipe 256 connects a recirculation outlet in the bottom of the surge vessel 246 to a coke inlet in the heater 280. A coke outlet standpipe 258 connects a cooler outlet in the surge vessel 246 to an inlet in the withdrawal cooler 264. A gas outlet line 232 connects an outlet in the surge vessel 246 to the reactor product line 230.

Returning to the heater 280, a coke outlet standpipe 285 connects an outlet nozzle in the heater 280 to a coke inlet riser 218 in the reactor 208. The heater includes an electrical heating element 282. A gas outlet line 248 connects the heater 280 to an inlet in the surge vessel 246. The inlet to the surge vessel 246 may be located above a surface 250 of a fluidized coke bed present during operation. A preheated gas feed inlet line 202 connects to a lower end of the reactor 208 and also connects with the coke inlet riser 218.

It is noted that the surge vessel 246 shown in FIG. 2 is optional. In other configurations, the cyclone dipleg 242 can pass particles into heater 280, such as in a configuration similar to what is shown in FIG. 1.

The withdrawal cooler 264 includes a heat exchanger 266 in fluid communication with a cooling fluid inlet 260 and in fluid communication with a cooling fluid outlet 262. A coke outlet in the lower end of the withdrawal cooler 266 is connected to a coke withdrawal outlet 274. A gas return line 252 connects the withdrawal cooler 264 to the surge vessel 250. The inlet to the surge vessel 248 may be located above a surface 250 of a fluidized coke bed present during operation.

Incorporating a larger diameter, lower velocity fluidized bed below the top riser 214 offers a region with substantially higher solids density, and substantially higher vapor residence time. This provides an increased extent of pyrolysis chemistry, and increases the amount of coke deposition on circulating coke particles, minimizing risk of equipment fouling and fine particulate “free coke” formation. The fluid bed transitions to a smaller diameter top riser 214 via a transition cone 212, in order to transition the solids flow regime to dilute transport, lifting the solids to the top of the riser into the cyclone 234. However, this shift of the flow regime to dilute transport occurs while still maintaining a solids density of 0.01 g/ft³ of gas or more, or 0.1 g/ft³ of gas or more.

The solids density in the top riser 214 is affected by several factors, but primarily by the solids circulation rate into the reactor from the inlet standpipe 285. Methods of controlling solids circulation rate are the same as described for the riser reactor system, including mechanical or non-mechanical valve options. The target solids circulation rate considers several factors, including the target riser reactor solids density to avoid equipment fouling and “free coke” formation; as well as the circulation rate required to deliver the required heat to the reactor vapors to control riser reactor temperature.

The withdrawal rate of pyrolysis coke is determined in part based on the rate of pyrolysis coke formation, which is in turn determined in part by gas residence time, feed rate, reactor size, pyrolysis temperature, and pyrolysis pressure. Still other factors are the extent of solids attrition in the circulating inventory, the rate of seed addition, and the size of seed particles. Yet another factor is the solids capture efficiency of the gas/solids separation equipment (i.e. cyclones). Still other factors are the reactor operating parameters, such as solids/gas ratio, temperature, pressure, and gas residence time that may impact carbon deposition rate.

The system 200 includes multiple lines providing fluidizing gas. The upper coke recirculation line 242 includes an inlet connected to a fluidizing gas line 244. The surge vessel 246 includes an inlet connected to a surge-vessel fluidizing gas line 254. The heater 280 includes an inlet connected to a heater fluidizing gas line 284. The cooler includes an inlet connected to a cooler fluidizing gas line 268. The withdrawal conduit 274 includes an inlet connected to withdrawal fluidizing gas line 272.

After a startup process, the reaction system 200 may reach steady state operating conditions that facilitate pyrolysis within the reactor 208 a circulation of a fluidized coke stream through the reactor 208, cyclone 234, surge vessel 246, and heater 280. Coke produced in the system 200 may be removed from the system typically through the withdrawal cooler 264.

The forced circulation fluid bed systems described herein move a solids circulation stream through the entire vertical height of the fluid bed vessel, into an overhead gas/solids separation device, such as a cyclone. Accordingly, in the context of a forced circulation pyrolysis system, coke particles will be present in some amount throughout the system. In contrast, a bubbling bed vessel in a circulating fluid bed system will typically feed a solids stream into the dense bubbling bed zone of the vessel, and withdraw solids from the dense bubbling bed zone. The vapor space above the dense bubbling bed zone will not have a forced circulation flow, but will only have a minimal solids entrainment depending on the gas velocity, gas properties and solid properties of the bubbling bed system. This entrainment in many systems may provide a very low solids fraction in the vapor space, which will potentially result in deleterious effects in a high temperature pyrolysis process (free coke formation and/or internals/wall coking which causes operational issues). In such conventional systems, the vapor space above the fluidized bed have less than the minimum coke density required to effectively limit coke formation on equipment surfaces.

The technology described herein uses a forced circulation fluid bed vessel on the reactor system of a gaseous hydrocarbon pyrolysis process. This includes, but is not limited to, pyrolysis of a methane-rich feedstock to produce hydrogen gas and a usable carbon product. The forced circulation reactor will have a zone at the top of the reactor to provide solids lift to the reactor overhead equipment, such as a cyclone. The lift may be achieved with a lift velocity of 20 to 80 ft/s (˜6.0 to 24 m/s) and sufficient solids circulation to produce above a minimum solids density in the upper lift zone. In aspects, the minimum solids density may be 0.01 to 10 lb/ft³ (0.16 to 160 kg/m³), or 0.02 to 10 lb/ft³ (0.32 to 160 kg/m³), or 0.05 to 10 lb/ft³ (0.80 to 160 kg/m³), or 0.1 to 10 lb/ft³ (1.6 to 160 kg/m³), or 0.3 to 10 lb/ft³ (4.8 to 160 kg/m³), or 0.7 to 10 lb/ft³ (11 to 160 kg/m³), or 1.0 to 10 lb/ft³ (16 to 160 kg/m³), or 1.0 to 5.0 lb/ft³ (16 to 80 kg/m³), or 0.7 to 5.0 lb/ft³ (11 to 80 kg/m³), or 0.3 to 5.0 lb/ft³ (4.8 to 80 kg/m³), or 0.1 to 5.0 lb/ft³ (1.6 to 80 kg/m³), or 0.05 to 5.0 lb/ft³ (0.80 to 80 kg/m³), or 0.02 to 5.0 lb/ft³ (0.32 to 80 kg/m³), or 0.01 to 5.0 lb/ft³ (0.16 to 80 kg/m³), or 0.01 to 2.0 lb/ft³ (0.16 to 32 kg/m³), or 0.02 to 2.0 lb/ft³ (0.32 to 32 kg/m³), or 0.05 to 2.0 lb/ft³ (0.80 to 32 kg/m³), or 0.1 to 2.0 lb/ft³ (1.6 to 32 kg/m³), or 0.3 to 2.0 lb/ft³ (4.8 to 32 kg/m³), or 1.0 to 2.0 lb/ft³ (16 to 32 kg/m³), or 0.01 to 0.5 lb/ft³ (0.16 to 8.0 kg/m³), or 0.02 to 0.5 lb/ft³ (0.32 to 8.0 kg/m³), or 0.05 to 0.5 lb/ft³ (0.80 to 8.0 kg/m³), or 0.1 to 0.5 lb/ft³ (1.6 to 8.0 kg/m³). In aspects, the lift velocity may be 20 to 80 ft/s (˜6.1 to 24 m/s), or 25 to 80 ft/s (˜7.6 to 24 m/s), or 30 to 80 ft/s (˜9.1 to 24 m/s), or 35 to 80 ft/s (˜11 to 24 m/s), or 40 to 80 ft/s (˜12 to 24 m/s), or 45 to 80 ft/s (˜14 to 24 m/s), or 50 to 80 ft/s (˜15 to 24 m/s), or 55 to 80 ft/s (˜17 to 24 m/s), or 60 to 80 ft/s (˜18 to 24 m/s), or 65 to 80 ft/s (˜20 to 24 m/s), or 70 to 80 ft/s (˜21 to 24 m/s), or 20 to 75 ft/s (˜6.1 to 23 m/s), or 20 to 65 ft/s (˜6.1 to 20 m/s), or 20 to 55 ft/s (˜6.1 to 17 m/s), or 20 to 45 ft/s (˜6.1 to 14 m/s), or 20 to 35 ft/s (˜6.1 to 11 m/s), or 20 to 30 ft/s (˜6.1 to 9.1 m/s), or 30 to 70 ft/s (˜9.1 to 21 m/s), or 40 to 60 ft/s (˜12 to 18 m/s), or 45 to 55 ft/s (˜14 to 17 m/s).

In some embodiments where the pyrolysis reactor corresponds to a forced circulation reactor, the lift riser zone of the reactor vessel will constitute the entire reactor vessel. In such embodiments, the reactor vessel can potentially have a constant diameter, or the diameter can vary to allow for roughly constant velocity in the reactor vessel as the molar volumetric flow and/or temperature changes as the pyrolysis reaction occurs. In such embodiments, the diameter can vary along the height of the reactor. In other embodiments, a lower velocity section could be installed below the riser lift zone to provide additional vapor and/or solids contact time to achieve a higher level of reaction conversion. The diameter of this lower velocity section or zone can be greater than the diameter of the riser lift section or zone. This lower velocity zone would be designed for a bubbling, turbulent, or fast fluidized operating regime, in a velocity range from 0.1 ft/s to 10 ft/s (˜0.03 to 3.0 m/s), or 0.1 ft/s to 7.0 ft/s (˜0.03 to 2.1 m/s), or 0.1 ft/s to 6.0 ft/s (˜0.03 to 1.8 m/s), or 0.5 ft/s to 10 ft/s (˜0.15 to 3.0 m/s), or 0.5 ft/s to 7.0 ft/s (˜0.15 to 2.1 m/s), or 0.5 ft/s to 6.0 ft/s (˜0.15 to 1.8 m/s), or 2.0 ft/s to 10 ft/s (˜0.6 to 3.0 m/s), or 2.0 ft/s to 7.0 ft/s (˜0.6 to 2.1 m/s), or 2.0 ft/s to 6.0 ft/s (˜0.6 to 1.8 m/s). The solids density in the lower zone can be from 20% to 100% of minimum fluidization density, or 50% to 90%, or 65% to 80%. The residence time of the methane gas (or other hydrocarbon gas) in this lower zone can be 1.0 seconds-20 seconds, or 1.0 seconds to 15 seconds, or 1.0 seconds to 10 seconds, or 2.0 seconds to 20 seconds, or 2.0 seconds to 15 seconds, or 2.0 seconds to 10 seconds, or 3.0 seconds to 20 seconds, or 3.0 seconds to 15 seconds, or 3.0 seconds to 10 seconds. This residence time can be selected so that the gas spends a sufficient amount of time within the lower section to achieve a desired or target amount of conversion to pyrolysis products. The bottom, lower velocity reactor section then transitions to the upper, higher velocity riser through a transition zone. In such a configuration where a bottom section has a higher solids density and a riser portion has a lower density, the riser portion of the vessel can have a solids density of 1.0 to 5.0 lb/ft³ (16 to 80 kg/m³), or 0.7 to 5.0 lb/ft³ (11 to 80 kg/m³), or 0.3 to 5.0 lb/ft³ (4.8 to 80 kg/m³), or 0.1 to 5.0 lb/ft³ (1.6 to 80 kg/m³), or 0.05 to 5.0 lb/ft³ (0.80 to 80 kg/m³), or 0.02 to 5.0 lb/ft³ (0.32 to 80 kg/m³), or 0.01 to 5.0 lb/ft³ (0.16 to 80 kg/m³), or 0.01 to 2.0 lb/ft³ (0.16 to 32 kg/m³), or 0.02 to 2.0 lb/ft³ (0.32 to 32 kg/m³), or 0.05 to 2.0 lb/ft³ (0.80 to 32 kg/m³), or 0.1 to 2.0 lb/ft³ (1.6 to 32 kg/m³), or 0.3 to 2.0 lb/ft³ (4.8 to 32 kg/m³), or 1.0 to 2.0 lb/ft³ (16 to 32 kg/m³), or 0.01 to 0.5 lb/ft³ (0.16 to 8.0 kg/m³), or 0.02 to 0.5 lb/ft³ (0.32 to 8.0 kg/m³), or 0.05 to 0.5 lb/ft³ (0.80 to 8.0 kg/m³), or 0.1 to 0.5 lb/ft³ (1.6 to 8.0 kg/m³). In such an aspect, the lower portion of the reactor vessel can have a higher solids density. The riser portion of the vessel can have a sufficient height to achieve a fully developed flow prior to exiting from the reactor, but short enough to reduce or minimize pyrolysis within the more dilute conditions of the riser portion. The height of the riser portion can be 5.0 ft to 200 ft (˜1.5 m˜61 m), or 20 ft to 100 ft (˜6.1 m to ˜30 m), or 30 ft to 70 ft (˜9.1 m to ˜21 m).

During operation of a pyrolysis reaction system based on a forced circulation reactor, pyrolysis of the hydrocarbon feedstock is performed in a reactor vessel as described above. This results in formation of a gas/solids mixture containing a pyrolysis effluent and pyrolysis coke particles that include at least a portion of pyrolysis coke that was deposited on the particles during transit through the reactor. The gas/solids mixture exiting the reactor is then routed to a series of additional equipment stages to perform various tasks in order to facilitate continuous operation.

One task is to separate the pyrolysis gas phase effluent, containing the hydrogen product, from the solids in the gas/solids mixture. To achieve this, the gas/solids mixture is passed into one or more separation stages, such as cyclone stages and/or filtration stages, to separate pyrolysis effluent vapors from the circulating solids stream. In some embodiments, the solids density for the gas/solids mixture is maintained at 0.01 lb/ft³ (˜0.16 kg/m³) or more until the gas/solids mixture enters the separation stage, or 0.1 lb/ft³ (˜1.6 kg/m³) or more, such as up the solids density that was in the pyrolysis reactor or possibly still higher.

In aspects where at least a portion of the heat for pyrolysis is provided by heating outside of the reactor, another task is to modify the temperature(s) of the various portions of the gas/solids flow exiting from the pyrolysis vessel. The gas phase portion of the pyrolysis effluent may be cooled or quenched to terminate pyrolysis chemistry, so that nucleation of additional particles and/or coking of downstream equipment is reduced or minimized. Alternatively, the gas phase portion of the pyrolysis effluent may be used to preheat feed or fuel streams. The circulating solids are heated in order to provide heat to the pyrolysis reactor vessel. This heating can be performed in any convenient manner, such as electric heating, heating by direct contact with a heated fluid (such as a combustion effluent), and/or by indirect heating.

Still another task is management of the solids within the overall reaction system, which includes withdrawing a solids product from the reaction system, and introduction of seed particles in embodiments where ex-situ seeds are used. Although withdrawal of product solids could be performed from the pyrolysis reactor vessel, more typically the solids product withdrawal will be performed at other location(s) in the reaction system in order to avoid loss of hydrogen due to entrainment with the solids product. Seed introduction can typically be performed at a location other than the pyrolysis reactor vessel.

Optionally, management of the solids inventory can be facilitated by having at least one vessel that allows for a variable level of solid inventory. This at least one vessel can be a separate “surge” vessel, or the vessel used for heating the solids inventory can be operated to allow for variable inventory. Such a vessel can be operated, for example, as a bubbling bed style of fluidized bed.

Other optional tasks that may also be desirable include, but are not limited to, stripping entrained hydrocarbon gas from the circulating solids, stripping fine particulates from circulating solids, and/or controlled attrition of circulating solids to facilitate control of particle size.

In this discussion, the average residence time for coke particles within a reaction system is defined as the weight of the solids inventory divided by the withdrawal rate of pyrolysis coke from the reaction system. It is noted that the total weight of pyrolysis coke particles in a reaction system, which corresponds to the inventory of pyrolysis coke particles, may vary during operation. For purposes of determining the residence time, in embodiments where the inventory level varies with time, the inventory level is calculated as the average inventory during one minute of operation. Thus, during any given minute of operation, an average residence time is defined as the average weight of pyrolysis coke inventory within the reaction system during the one minute time period, divided by the pyrolysis coke withdrawal rate during the one minute time period. Based on this definition for the average residence time, the average residence time of pyrolysis coke particles in a reaction system will be on the order of hours. In some embodiments, the average residence time for pyrolysis coke particles is 0.5 hours to 500 hours, or 0.5 hours to 100 hours, or 0.5 hours to 50 hours, or 0.5 hours to 20 hours, or 1.0 hours to 500 hours, or 1.0 hours to 100 hours, or 1.0 hours to 50 hours, or 1.0 hours to 20 hours.

The withdrawal rate of pyrolysis coke is determined in part based on the rate of pyrolysis coke formation, which is in turn determined in part by gas residence time, feed rate, reactor size, pyrolysis temperature, and pyrolysis pressure. Still other factors are the extent of solids attrition in the circulating inventory, the rate of seed addition, and the size of seed particles. Yet another factor is the solids capture efficiency of the gas/solids separation equipment (i.e. cyclones). Still other factors are the reactor operating parameters, such as solids/gas ratio, temperature, pressure, and gas residence time that may impact carbon deposition rate.

### Hydrocarbon Feedstock

A variety of hydrocarbon feedstocks can be used as the input feed for pyrolysis. Generally, any convenient type of hydrocarbon that corresponds to a gas at the input temperature for the hydrocarbon feed into the pyrolysis reactor could be used as part of the hydrocarbon feedstock. In some aspects, the hydrocarbon feedstock can contain 50 mol % or more of C₁-C₄ hydrocarbons, or 60 mol % or more, or 70 mol % or more, or 80 mol % or more, or 90 mol % or more, or 95 mol % or more, or 99 mol % or more, such as up to being substantially composed of C₁-C₄ hydrocarbons (99.9 mol % or more). In some aspects, the hydrocarbon feedstock can contain 50 mol % or more of methane (C₁ hydrocarbon), or 60 mol % or more, or 70 mol % or more, or 80 mol % or more, or 90 mol % or more, or 95 mol % or more, or 99 mol % or more, such as up to being substantially composed of methane (99.9 mol % or more). In some aspects, the hydrocarbon feedstock can include 20 mol % or less of C₅₊ hydrocarbons, or 10 mol % or less, or 5.0 mol % or less, or 1.0 mol % or less, such as down to having substantially no content of C₅₊ hydrocarbons (0.1 mol % or less). In other aspects, the hydrocarbon feedstock can correspond to a feedstock with a substantial naphtha content. In such aspects, the hydrocarbon feedstock can contain 40 mol % or more of C₅₊ components, or 55 mol % or more, or 70 mol % or more, or 90 mol % or more, such as up to being substantially composed of C₅₊ components (100 mol %). In addition to hydrocarbons, a hydrocarbon feed can also include diluent components that do not substantially impact the pyrolysis process, such as N₂.

Such a hydrocarbon feedstock can be derived from a variety of sources, depending on the embodiment. One option is to use a mineral hydrocarbon feed, such as natural gas. Optionally, methane could be separated from a mineral hydrocarbon feed in order to provide a feed having higher methane content and/or reduced contaminant content into the pyrolysis process. Additionally or alternately, other sources of methane, such as by-product streams from refinery processing that include a substantial portion of methane, can also be used.

Other sources of methane can be derived from biological and/or renewable sources. Various options are available for conversion of biomass and/or municipal solid waste into smaller hydrocarbons, such as bio-methane. It is noted that some types of bio-derived feeds can also have measurable oxygen contents, which could pose difficulties within a pyrolysis environment. Thus, in some aspects, a bio-derived feed can undergo one or more types of hydroprocessing (such as hydrodeoxygenation or other hydrotreatment) so that the resulting bio-derived feed has substantially no oxygen content.

### Seed Particles and Particle Size

In various aspects, seed particles, such as coke seed particles, can be used to assist with managing the size of coke particles within the forced circulation reaction environment. Optionally, seed particle addition can also be used, in combination with control of coke withdrawal rate, as part of management of the inventory of coke particles in the reaction system. Depending the aspect, seed particles introduced into the forced circulation reaction system can be heterogeneous seed particles, homogeneous seed particles, or a combination thereof.

Coke seed particles can be provided to the system during start up, but also (optionally) during operation to maintain particle size distribution within the desired range. For example, the withdrawal system may be operated to return smaller particles to the system as seed coke and include the larger withdrawn coke particles in the systems coke output. In such embodiments, a portion of withdrawn coke particles may be removed from the system, processed, and then used as seed if it meets various characteristics, or after optional further processing of the withdrawn portion to adjust particle size.

In some embodiments, the seed particle introduced into the fluidized bed corresponds to seed particles composed of pyrolysis coke. In such embodiments, the composition of the pyrolysis coke particles can be relatively uniform throughout the particles, as both the seed and the outer shell of pyrolysis coke correspond to substantially the same material.

It is noted that for seeds composed of pyrolysis coke, the seeds can correspond to seeds that are generated “ex situ” or “in situ”. Ex-situ generated seeds represent seeds that are formed outside of the pyrolysis system environment. In-situ generated seeds correspond to seeds that are formed within the pyrolysis system, such as by performing forced attrition on a portion of the particles within the system.

In other embodiments, a heterogeneous seed is used to form the pyrolysis coke particles. In other words, the seed used for forming the particle is a carbonaceous material different from pyrolysis coke. Examples of potential heterogeneous seed materials include, but are not limited to, fluidized coke, flexicoke, delayed coke (such as shot coke, sponge coke, anode-grade coke, and needle coke), coal, coal coke, metallurgical coke, charcoal, hard carbon, activated carbon, natural or synthetic graphite, amorphous carbon, and glassy/vitreous carbon. It is noted that activated coke and/or calcined coke formed from fluidized coke, flexicoke, delayed coke, coal, coal coke, and metallurgical coke can also be used as a heterogeneous seed. In this discussion, a carbonaceous particle or material (for example, a carbonaceous seed particle, a carbonaceous core in a core-and-shell structure, a pyrolysis coke particle with a homogeneous core) is defined as a particle or material that contains at least 50 wt % of carbon. Thus, particles or materials containing 50 wt % or more of carbon, or 70 wt % or more of carbon, or 90 wt % or more of carbon, such as up to 100 wt % carbon, all qualify as carbonaceous particles or materials. Because the seed materials may have higher concentrations of atoms different from carbon atoms and hydrogen atoms, the use of heterogeneous seeds can reduce the purity of the resulting pyrolysis coke particles.

When a heterogeneous seed is used, in some embodiments, the average thickness of the pyrolysis coke shell around the heterogeneous seed can be relatively thin. The average thickness is defined as the average distance from the interface of the heterogeneous seed and the pyrolysis coke shell to the closest location on the exterior of the pyrolysis coke shell. Such a distance can be determined, for example, by visual inspection of SEM images of sectioned samples. In such embodiments, the average thickness of the pyrolysis coke shell is 100 μm or less, or 50 μm or less, or 30 μm or less, or 20 μm or less, or 16 μm or less, or 12 μm or less, such as down to 4.0 μm, or down to 2.0 μm, or possibly still lower. Additionally or alternately, in some embodiments, the average thickness of the pyrolysis coke shells is less than the average diameter of the heterogeneous seeds, or less than 0.5 times the average diameter of the heterogeneous seeds (in other words, less than half the diameter), or less than 0.25 times the average diameter of the heterogeneous seeds (in other words, less than a quarter of the diameter). In this discussion, the average diameter of the heterogeneous seeds is determined based on the volume average of the diameters in the distribution of seeds. For seeds that are not spherical, the diameter is defined as the spherical equivalent diameter that is determined by light scattering.

### Additional Embodiments

Embodiment 1. A process for performing hydrocarbon pyrolysis, comprising: pyrolyzing a hydrocarbon-containing flow in the presence of solid particles under pyrolysis conditions in a reactor to form an H₂-containing effluent and coke deposited on at least a portion of the solid particles, the hydrocarbon-containing flow and the solid particles forming a gas-solids mixture within the reactor under forced circulation conditions, substantially all of the gas-solids mixture having a solids density of 0.1 lbs/ft³ (˜1.6 kg/m³) or more while exposed to pyrolysis conditions within the reactor, the gas-solids mixture having a gas velocity of 0.1 ft/s (˜0.03 m/s) or more while exposed to pyrolysis conditions within the reactor, at least a portion of the gas-solids mixture exposed to the pyrolysis conditions within the reactor having a gas velocity of 20 ft/s (˜6.1 m/s) or more, the pyrolysis conditions comprising a temperature of 700° C. to 1600° C.; passing the H₂-containing effluent and a transfer portion of the solid particles in the gas-solids mixture upwards through the reactor into a separation vessel to produce an H₂-containing product and a solids product comprising solid particles having deposited coke; and passing at least a portion of the solids product into the reactor.

Embodiment 2. The method of Embodiment 1, wherein the gas-solids mixture comprises a fluidized bed portion having a gas velocity of 0.1 ft/s (˜0.03 m/s) or more and a dilute phase having a solids density of 0.1 lbs/ft³ (˜1.6 kg/m³) or more and a gas velocity of 20 ft/s (˜6.1 m/s) or more, wherein optionally a lift velocity in the fluidized bed portion maintains a solids density of 25% to 100% of minimum fluidization density.

Embodiment 3. The method of Embodiment 1, wherein the gas/solids mixture is a suspension of solid particles having a gas velocity of 20 ft/s (˜6.1 m/s) or more.

Embodiment 4. The method of any of the above embodiments, wherein the feed comprises 50 vol % or more of C₁-C₄ hydrocarbons, or wherein the feed is substantially composed of C₁-C₄ hydrocarbons, the feed optionally comprising 50 vol % or more of methane.

Embodiment 5. The method of any of Embodiments 1 to 3, wherein the feed comprises 50 vol % or more of naphtha boiling range compounds, gas oil boiling range compounds, or a combination thereof.

Embodiment 6. The method of any of the above embodiments, wherein the solid particles comprise catalyst particles.

Embodiment 7. The method of any of the above embodiments, wherein the pyrolysis temperature is 800° C. to 1600° C., or wherein the pyrolysis temperature is 1000° C. to 1300° C.

Embodiment 8. The method of any of the above embodiments, wherein substantially all of the gas-solids mixture has a solids density of 0.5 lbs/ft³ (˜8.0 kg/m³) or more while exposed to pyrolysis conditions within the reactor.

Embodiment 9. The method of any of the above embodiments, a) wherein the solid particles are heated by electric heating; b) wherein the solid particles are heated in a furnace; c) wherein the solid particles are heated by indirect heating; or d) a combination of two or more of a), b), and c).

Embodiment 10. The method of any of the above embodiments, wherein the solid particles are heated in a separate vessel, the method further comprising passing the at least a portion of the solids product into the separate vessel, heating the at least a portion of the solids product, and passing the heated at least a portion of the solids product into the reactor.

Embodiment 11. The method of any of the above embodiments, wherein a second portion of the solids product undergoes further processing, and wherein the method further comprises passing seed particles into the reactor, the seed particles optionally comprising pyrolysis carbon.

Embodiment 12. The method of Embodiment 11, wherein the seed coke particles are generated ex-situ, or wherein the seed coke particles are generated in-situ, or a combination thereof.

Embodiment 13. The method of any of the above embodiments, wherein a rate of passing the at least a portion of the solids product into the reactor is controlled using a mechanical valve, a non-mechanical valve, or a combination thereof.

Embodiment 14. The method of any of the above embodiments, wherein the separation vessel comprises a cyclone separator.

Embodiment 15. The method of any of the above embodiments, wherein the solids product is passed into a surge vessel containing a reservoir of the solid particles, and wherein passing at least a portion of the solids product into the reactor comprises passing solid particles from the reservoir of solid particles into the reactor.

Embodiment 16. The method of any of the above embodiments, wherein the method further comprises stripping the solids product to remove hydrocarbon gases, or wherein the method further comprises stripping the solids product to remove fine particulates, or a combination thereof.

Embodiment 17. The method of any of the above embodiments, further comprising performing in-situ attrition on an attrition portion of the solids product to form a reduced particle size portion, the at least a portion of the solids product including the reduced particle size portion.

Embodiment 18. The method of any of the above embodiments, wherein the forced circulation reactor is a riser reactor with a substantially constant diameter; or wherein a diameter of the forced circulation reactor varies along the height of the reactor; or wherein the forced circulation reactor comprises a lower zone and a riser zone, the lower zone having a larger diameter than the riser zone.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A process for performing hydrocarbon pyrolysis, comprising:
pyrolyzing a hydrocarbon-containing flow in the presence of solid particles under pyrolysis conditions in a reactor to form an H₂-containing effluent and coke deposited on at least a portion of the solid particles, the hydrocarbon-containing flow and the solid particles forming a gas-solids mixture within the reactor under forced circulation conditions, substantially all of the gas-solids mixture having a solids density of 0.1 lbs/ft³ or more while exposed to pyrolysis conditions within the reactor, the gas-solids mixture having a gas velocity of 0.1 ft/s or more while exposed to pyrolysis conditions within the reactor, at least a portion of the gas-solids mixture exposed to the pyrolysis conditions within the reactor having a gas velocity of 20 ft/s or more, the pyrolysis conditions comprising a temperature of 700° C. to 1600° C.;
passing the H₂-containing effluent and a transfer portion of the solid particles in the gas-solids mixture upwards through the reactor into a separation vessel to produce an H₂-containing product and a solids product comprising solid particles having deposited coke; and
passing at least a portion of the solids product into the reactor.

2. The method of claim 1, wherein the gas-solids mixture comprises a fluidized bed portion having a gas velocity of 0.1 ft/s or more, and a dilute phase having a solids density of 0.1 lbs/ft³ or more and a gas velocity of 20 ft/s or more.

3. The method of claim 2, wherein a lift velocity in the fluidized bed portion maintains a solids density of 25% to 100% of minimum fluidization density.

4. The method of claim 1, wherein the gas/solids mixture is a suspension of solid particles having a gas velocity of 20 ft/s or more.

5. The method of claim 1, wherein the feed comprises 50 vol % or more of C₁-C₄ hydrocarbons.

6. The method of claim 5, wherein the feed comprises 50 vol % or more of methane, or wherein the feed is substantially composed of C₁-C₄ hydrocarbons, or a combination thereof.

7. The method of claim 1, wherein the feed comprises 50 vol % or more of naphtha boiling range compounds, gas oil boiling range compounds, or a combination thereof.

8. The method of claim 1, wherein the solid particles comprise catalyst particles.

9. The method of claim 1, wherein the pyrolysis temperature is 800° C. to 1600° C.

10. The method of claim 1, wherein substantially all of the gas-solids mixture has a solids density of 0.5 lbs/ft³ or more while exposed to pyrolysis conditions within the reactor.

11. The method of claim 1, a) wherein the solid particles are heated by electric heating; b) wherein the solid particles are heated in a furnace; c) wherein the solid particles are heated by indirect heating; or d) a combination of two or more of a), b), and c).

12. The method of claim 1, wherein the solid particles are heated in a separate vessel, the method further comprising passing the at least a portion of the solids product into the separate vessel, heating the at least a portion of the solids product, and passing the heated at least a portion of the solids product into the reactor.

13. The method of claim 1, wherein a second portion of the solids product undergoes further processing, and wherein the method further comprises passing seed particles into the reactor.

14. The method of claim 13, wherein the seed particles comprise pyrolysis carbon.

15. The method of claim 13, wherein the seed coke particles are generated ex-situ, or wherein the seed coke particles are generated in-situ, or a combination thereof.

16. The method of claim 1, wherein a rate of passing the at least a portion of the solids product into the reactor is controlled using a mechanical valve, a non-mechanical valve, or a combination thereof.

17. The method of claim 1, wherein the separation vessel comprises a cyclone separator.

18. The method of claim 1, wherein the forced circulation reactor is a riser reactor with a substantially constant diameter, or wherein a diameter of the forced circulation reactor varies along the height of the reactor.

19. The method of claim 1, wherein the forced circulation reactor comprises a lower zone and a riser zone, the lower zone having a larger diameter than the riser zone.

20. The method of claim 1, wherein the solids product is passed into a surge vessel containing a reservoir of the solid particles, and wherein passing at least a portion of the solids product into the reactor comprises passing solid particles from the reservoir of solid particles into the reactor.

21. The method of claim 1, wherein the method further comprises stripping the solids product to remove hydrocarbon gases, or wherein the method further comprises stripping the solids product to remove fine particulates, or a combination thereof.

22. The method of claim 1, further comprising performing in-situ attrition on an attrition portion of the solids product to form a reduced particle size portion, the at least a portion of the solids product including the reduced particle size portion.
